(19) United States
(12) Patent Application Publication
(10) Pub. No.: US 2013/0219799 A1
(43) Pub. Date: Aug. 29, 2013

(54) GLASS RUN INTEGRAL MOLDING AND DOOR FRAME STRUCTURE

(71) Applicants: Katsuhiko Takeuchi, Canton, MI (US); Hiroaki Yamasaki, Canton, MI (US); Eisuke Sato, Nagoya-shi (JP)

(72) Inventors: Katsuhiko Takeuchi, Canton, MI (US); Hiroaki Yamasaki, Canton, MI (US); Eisuke Sato, Nagoya-shi (JP)

(21) Appl. No.: 13/881,565

(22) PCT Filed: Oct. 7, 2011
(86) PCT No.: PCT/JP2011/073752

§ 371 Date: Apr. 25, 2013

(30) Foreign Application Priority Data
Oct. 26, 2010 (JP) 2010-239788
Mar. 31, 2011 (JP) 2011-77796

(51) Int. Cl. B60J 10/04; B60J 10/08

(52) U.S. Cl. CPC B60J 10/04; B60J 10/08
USPC 49/472

(57) ABSTRACT

To prevent easy removal of a glass run integral molding from a door frame, provided is a glass run integral molding to be assembled to an upper part of a door frame surrounding a window opening of a vehicle door. The glass run integral molding includes an outer peripheral-side side wall portion and an inner peripheral-side side wall portion for sandwiching a flange portion of the upper part, a car outer-side side wall portion for connecting a car outer-side end portion of the outer peripheral-side side wail portion and that of the inner peripheral-side side wall portion to each other and extending along a door glass surface, glass run portions for sealing a peripheral edge of a door glass, and body seal lip portions for sealing a clearance between the vehicle door and a vehicle body. The glass run integral molding also includes an outer peripheral-side engagement portion for coming into elastic engagement with a first engagement portion formed on an outer peripheral side of the upper part from the outer peripheral side and an inner peripheral-side engagement portion for coming into elastic engagement with a second engagement portion formed on an inner peripheral side of the upper part from the inner peripheral side.

### TECHNICAL FIELD

The present invention relates to a glass run integral molding adapted to be assembled to a door frame surrounding a window opening of a vehicle door and a door frame structure including the glass run integral molding and the door frame.

### RELATED ART

A glass run integral molding (a molding with which a glass run is integrated) to be assembled to a door frame surrounding a window opening of a vehicle door is described in, for example, JP 2005-153581 A. The glass run integral molding, which is described in JP 2005-153581 A, includes an outer peripheral-side side wall portion and an inner peripheral-side side wall portion, a car outer-side side wall portion, a glass run portion, and a body seal lip portion in an integrated manner. The outer peripheral-side side wall portion and the inner peripheral-side side wall portion sandwich a flange portion formed on an upper part of a door frame. The car outer-side side wall portion connects a car outer-side end portion of the outer peripheral-side side wall portion and that of the inner peripheral-side side wall portion to each other and extends along a door glass surface. The glass run portion is formed so as to extend from the inner peripheral-side side wall portion and the car outer-side side wall portion to seal a peripheral edge of a door glass. The body seal lip portion is formed so as to extend from the outer peripheral-side side wall portion to an outer peripheral side to seal a clearance between a vehicle door and a vehicle body. The glass run integral molding also includes an outer peripheral-side engagement portion and an inner peripheral-side engagement portion in an integrated manner. The outer peripheral-side engagement portion is formed so as to extend from the outer peripheral-side side wall portion to come into elastic engagement with a first engagement portion formed on the outer peripheral side of the flange portion of the door frame from the outer peripheral side. The inner peripheral-side engagement portion is formed so as to extend from the inner peripheral-side side wall portion to come into elastic engagement with a second engagement portion formed on the door frame from the outer peripheral side.

### SUMMARY OF THE INVENTION

According to the glass run integral molding described in JP 2005-153581 A mentioned above, a direction in which the outer peripheral-side engagement portion comes into engagement with the first engagement portion and a direction in which the inner peripheral-side engagement portion comes into engagement with the second engagement portion are the same, that is, from the outer peripheral side to the inner peripheral side. Therefore, when the door glass is closed, the glass run integral molding is pushed up from the inner peripheral side to the outer peripheral side to weaken both an engagement force of the outer peripheral-side engagement portion to the first engagement portion and an engagement force of the inner peripheral-side engagement portion to the second engagement portion. As a result, the glass run integral molding is more likely to be undesirably removed from the door frame.

The present invention has been made to solve the above-mentioned problem, and provides a glass run integral molding adapted to be assembled to a door frame surrounding a window opening of a vehicle door, including: an outer peripheral-side side wall portion and an inner peripheral-side side wall portion for sandwiching a flange portion provided to the door frame; a car outer-side side wall portion for connecting a car outer side end portion of the outer peripheral-side side wall portion and a car outer side end portion of the inner peripheral-side side wall portion to each other and extending along a door glass surface; a glass run portion formed so as to extend from the inner peripheral-side side wall portion and the car outer-side side wall portion to seal a peripheral edge of a door glass; a body seal lip portion formed so as to extend from the outer peripheral-side side wall portion toward an outer peripheral side to seal a clearance between the vehicle door and a vehicle body; an outer peripheral-side engagement portion formed so as to extend from the outer peripheral-side side wall portion, for coming into elastic engagement with a first engagement portion formed on an outer peripheral side of the door frame from the outer peripheral side; and an inner peripheral-side engagement portion formed so as to extend from the inner peripheral-side side wall portion, for coming into elastic engagement with a second engagement portion formed on an inner peripheral side of the door frame from the inner peripheral side.

For carrying out the present invention described above, the glass run portion and the body seal lip portion may be made of a soft resin, the outer peripheral-side side wall portion, the inner peripheral-side side wall portion, and the car outer-side side wall portion may be made of a hard resin harder than the soft resin, at least a part of one of the outer peripheral-side engagement portion and the inner peripheral-side engagement portion may be made of the hard resin, and another one of the outer peripheral-side engagement portion and the inner peripheral-side engagement portion may be made of the soft resin. Further, the glass run integral molding according to the present invention may include at least one of: a first reinforcing lip having a distal end portion for coming into elastic engagement with the door frame to enhance an elastic engagement force of the outer peripheral-side engagement portion to the first engagement portion; and a second reinforcing lip having a distal end portion for coming into elastic engagement with the door frame to enhance an elastic engagement force of the inner peripheral-side engagement portion to the second engagement portion.

Further, the present invention provides a door frame structure, including: a door frame having a flange portion and surrounding a window opening of a vehicle door; and a glass run integral molding to be assembled to the door frame, including: an outer peripheral-side side wall portion and an inner peripheral-side side wall portion for sandwiching the flange portion of the door frame; a car outer-side side wall portion for connecting a car outer-side end portion of the outer peripheral-side side wall portion and a car outer-side end portion of the inner peripheral-side side wall portion to each other and extending along a door glass surface; a glass run portion formed so as to extend from the inner peripheral-side side wall portion and the car outer-side side wall portion to seal a peripheral edge of a door glass; a body seal lip portion formed so as to extend from the outer peripheral-side side wall portion toward an outer peripheral side to seal a clearance between the vehicle door and a vehicle body; an outer peripheral-side engagement portion formed so as to extend from the outer peripheral-side side wall portion, for coming into elastic engagement with a first engagement portion formed on an outer peripheral side of the door frame from the outer peripheral side; and an inner peripheral-side engagement portion formed so as to extend from the inner peripheral-side side wall portion, for coming into elastic engagement with a second engagement portion formed on an inner peripheral side of the door frame from the inner peripheral side.

It is preferred that the door frame be formed by bending a thin steel plate so that the flange portion has a triple-layered structure in which an intermediate plate, an outer peripheral-side plate, and an inner peripheral-side plate are laminated. In this case, it is preferred that the first engagement portion be configured by a concave portion formed by protruding a car inner-side portion of the intermediate plate to the inner peripheral side and an end portion of the outer peripheral-side plate, which is provided so as to partially overlap the concave portion, and that the second engagement portion be configured by a projecting portion formed on the inner peripheral-side plate so as to correspond to the concave portion to project to the inner peripheral side.

According to the glass run integral molding and the door frame structure of the present invention, the outer peripheral-side engagement portion is configured to come into elastic engagement with the first engagement portion formed on the outer peripheral side of the door frame from the outer peripheral side, whereas the inner peripheral-side engagement portion is configured to come into elastic engagement with the second engagement portion formed on the inner peripheral side of the door frame from the inner peripheral side. Specifically, a direction in which the outer peripheral-side engagement portion comes into engagement with the first engagement portion and a direction in which the inner peripheral-side engagement portion comes into engagement with the second engagement portion are opposite to each other and therefore, are opposed to each other. According to this configuration, when the door glass is closed and the glass run integral molding is pushed up from the inner peripheral side to the outer peripheral side, an engagement force of the inner peripheral-side engagement portion to the second engagement portion is strengthened, although an engagement force of the outer peripheral-side engagement portion to the first engagement portion is weakened. As a result, an engagement force of the glass run integral molding to the door frame is maintained.

For carrying out the present invention, the glass run portion and the body seal lip portion are made of a soft resin. The outer peripheral-side side wall portion, the inner peripheral-side side wall portion, and the car outer-side side wall portion are made of a hard resin harder than the soft resin. At least a part of one of the outer peripheral-side engagement portion and the inner peripheral-side engagement portion is made of the hard resin, whereas another one of the outer peripheral-side engagement portion and the inner peripheral-side engagement portion is made of the soft resin. In this case, desired sealability can be obtained by the glass run portion and the body seal lip portion. In addition, desired design (external shape) can be ensured by the outer peripheral-side side wall portion, the inner peripheral-side side wall portion, and the car outer-side side wall portion. Moreover, a firm engagement force to the door frame can be obtained by the one of (hard-resin side) of the outer peripheral-side engagement portion and the inner peripheral-side engagement portion. In addition, assembly ease of the glass run integral molding to the door frame can be obtained by the another one (soft-resin side) of the outer peripheral-side engagement portion and the inner peripheral-side engagement portion.

For carrying out the present invention, the glass run integral molding includes at least one of: a first reinforcing lip having a distal end portion for coming into elastic engagement with the door frame to enhance an elastic engagement force of the outer peripheral-side engagement portion to the first engagement portion; and a second reinforcing lip having a distal end portion for coming into elastic engagement with the door frame to enhance an elastic engagement force of the inner peripheral-side engagement portion to the second engagement portion. In this case, assembly strength of the glass run integral molding to the door frame can be enhanced.

Moreover, for carrying out the present invention, the door frame is formed by bending a thin steel plate so that the flange portion has a triple-layered structure in which an intermediate plate, an outer peripheral-side plate, and an inner peripheral-side plate are laminated. The first engagement portion is configured by a concave portion formed by protruding a car inner-side portion of the intermediate plate to the inner peripheral side and an end portion of the outer peripheral-side plate, which is provided so as to partially overlap the concave portion. The second engagement portion is configured by a projecting portion formed on the inner peripheral-side plate so as to correspond to the concave portion to project to the inner peripheral side. In this case, the protruding portion for forming the concave portion can be located in the concave portion for forming the projecting portion. Therefore, a space for configuring the first engagement portion and the second engagement portion can be made small. Accordingly, the door frame can be reduced in size as well as in weight.

Further, for carrying out the present invention, the door frame may be formed by bending a thin steel plate so that the flange portion has a triple-layered structure in which an intermediate plate, an outer peripheral-side plate, and an inner peripheral-side plate are laminated, the first engagement portion may be configured by at least one of a convex portion and a concave portion respectively formed by protruding a car inner-side portion of the outer peripheral-side plate to a car inner side and a car outer side, and the second engagement portion may be configured by at least one of a second convex portion and a second concave portion formed by bending a car inner-side portion of the intermediate plate to the inner peripheral side and protruding the car inner-side portion to the car inner side and the outer peripheral side, and an end portion of the inner peripheral-side plate, which is bent to the inner peripheral side so as to partially overlap the second convex portion. In this case, a waterproof configuration of the door frame can be improved (for example, a waterproofing seal lip portion can be omitted) by the glass run integral molding. Thus, cost of the glass run integral molding can be reduced.

Further, for carrying out the present invention, the door frame may be formed by bending a thin steel plate so that the flange portion has a double-layered structure in which an outer peripheral-side plate and an inner peripheral-side plate are laminated, the first engagement portion may be configured by at least one of a convex portion and a concave portion respectively formed by protruding a car inner-side portion of the outer peripheral-side plate to a car inner side and a car outer side, and the second engagement portion may be configured by a second convex portion formed by bending a car inner-side portion of the inner peripheral-side plate to the inner peripheral side and then folding the car inner-side portion.

In this case, the flange portion of the door frame has the double-layered structure of the thin steel plate. Therefore, as compared with the case where the flange portion has the triple-layered structure of the thin steel plate, the weight of the door frame can be reduced. Moreover, an operation of firmly fixing a lower end portion of the door frame to the door panel (for example, a door inner panel) at the flange portion (for example, an operation of spot-welding three layers of the steel plate, including the door inner panel and the thin steel plate having the double-layered structure) can be easily performed as compared with an operation performed in the case where the flange portion has the triple-layered structure of the thin steel plate (for example, an operation of spot-welding four layers of the steel plate, including the door inner panel and the thin steel plate having the triple-layered structure).

### BRIEF DESCRIPTION OF THE DRAWING

FIG. 1 is a schematic diagram illustrating an embodiment (first embodiment) of a vehicle door in which a glass run integral molding according to the present invention is used only for an upper part of a door frame.

FIG. 2 is an enlarged sectional view of the first embodiment, taken along the line A-A of FIG. 1.

FIG. 3 is a sectional view of the glass run integral molding illustrated in FIG. 2 at a position different along a longitudinal direction (longitudinal direction of a vehicle) from the A-A line of FIG. 1.

FIG. 4 is a sectional view of the glass run integral molding illustrated in FIG. 2 in a free state.

FIG. 5 is a sectional view of the glass run integral molding illustrated in FIG. 3 in a free state.

FIG. 6 is a sectional view illustrating another embodiment (second embodiment) of the glass run integral molding according to the present invention, which corresponds to FIG. 2.

FIG. 7 is a sectional view illustrating a further embodiment (third embodiment) of the glass run integral molding according to the present invention, which corresponds to FIG. 2.

FIG. 8 is a sectional view illustrating a still further embodiment (fourth embodiment) of the glass run integral molding according to the present invention, which corresponds to FIG. 2.

FIG. 9 is a sectional view illustrating a yet further embodiment (fifth embodiment) of the glass run integral molding according to the present invention, which corresponds to FIG. 2.

FIG. 10 is a sectional view illustrating a yet further embodiment (sixth embodiment) of the glass run integral molding according to the present invention, which corresponds to FIG. 2.

FIG. 11 is a schematic diagram illustrating an embodiment in which the glass run integral molding according to the present invention is used for both the upper part and a column part of the door frame (embodiment in which a garnish is not provided to the column part of the door frame).

### DESCRIPTION OF EMBODIMENTS

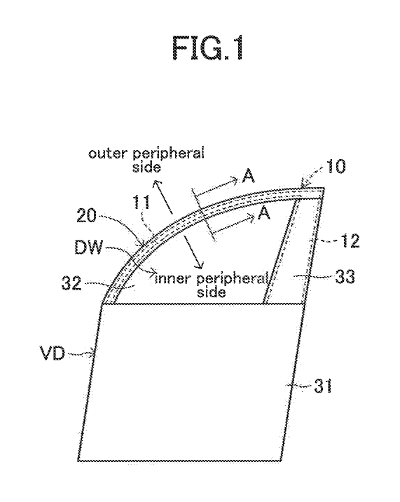

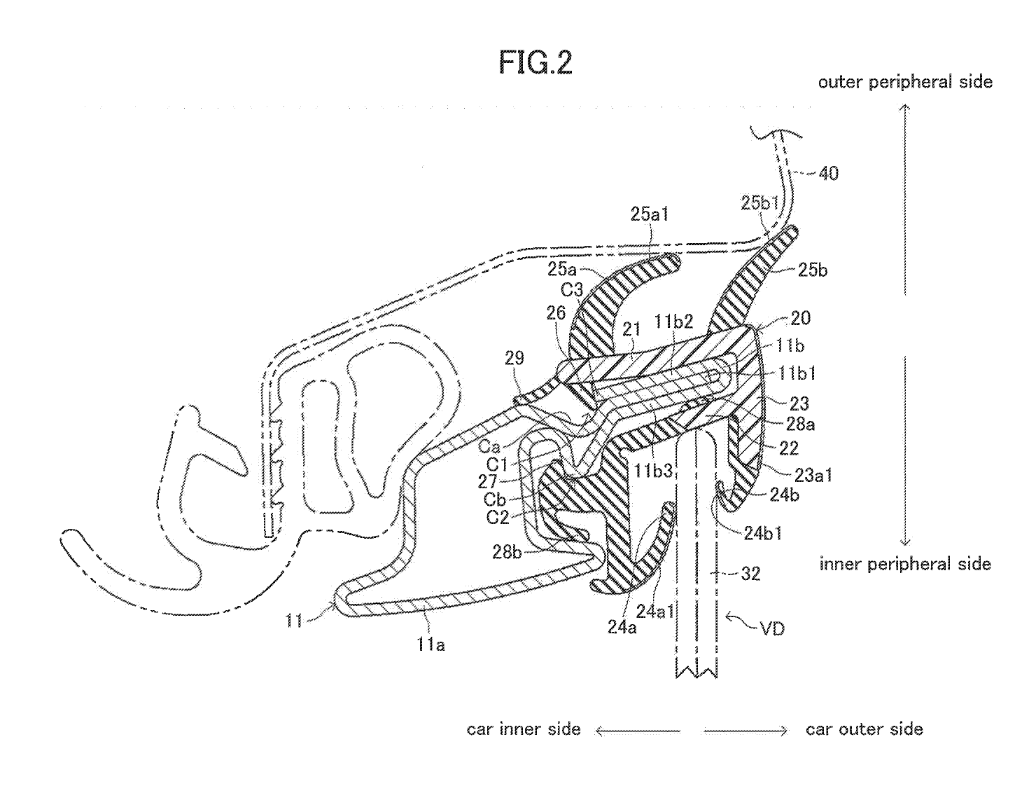

Hereinafter, embodiments of the present invention are described with reference to the drawings. FIG. 1 schematically illustrates an embodiment of a vehicle door VD for which a glass run integral molding of the present invention is used. As illustrated in FIG. 2 which is a sectional view taken along the line A-A of FIG. 1, a glass run integral molding 20 is assembled to an upper part 11 of a door frame 10 of the vehicle door VD in this embodiment. The vehicle door VD is a front door including the door frame 10, a door panel 31, and a door glass 32. A window opening DW is formed by the door frame 10 and the door panel 31. The window opening DW can be opened and closed by the door glass 32 which can be moved up and down. In this embodiment, the upper part 11 has an arc-like shape as illustrated in FIG. 1. A direction closer to the center of the upper part 11 having the arc-like shape is defined as “inner peripheral side”, whereas a direction away from the center is defined as “outer peripheral side”.

The door frame 10 is formed above the door panel 31 so as to surround the window opening DW. As illustrated in FIG. 1, the door frame 10 includes the upper part 11 and a column part 12. To a car outer side (on the right of FIG. 2) of the upper part 11, the glass run integral molding 20 is assembled. To a car outer side of the column part 12, a garnish 33 is assembled. The upper part 11 is formed by bending a thin steel plate as illustrated in FIG. 2, and includes a hollow base portion 11a and a flange portion 11b having a triple-layered structure.

As illustrated in FIG. 2, the flange portion 11b has the triple-layered structure in which an intermediate plate 11b1, an outer peripheral-side plate 11b2, and an inner peripheral-side plate 11b3 are laminated. The layers of the steel plate are spot-welded at an overlapping portion. A car inner-side portion of the intermediate plate 11b1 is protruded to the inner peripheral side to form a concave portion Ca. An end (car inner-side end) portion C3 of the outer peripheral-side plate 11b2 is provided so as to partially overlap a car outer-side portion of the concave portion Ca. A first engagement portion C1 is configured by the concave portion Ca and the end portion C3 of the outer peripheral-side plate 11b2. In the flange portion 11b, a projecting portion Cb is formed on a car inner-side portion of the inner peripheral-side plate 11b3 so as to correspond to the concave portion Ca (so as to partially overlap an inner peripheral-side wall surface of the concave portion Ca). A second engagement portion C2 is configured by the projecting portion Cb. The projecting portion Cb is formed so as to project to the inner peripheral side. A part of the concave portion Ca is present in a space portion (interior) surrounded by wall surfaces constituting the projecting portion Cb.

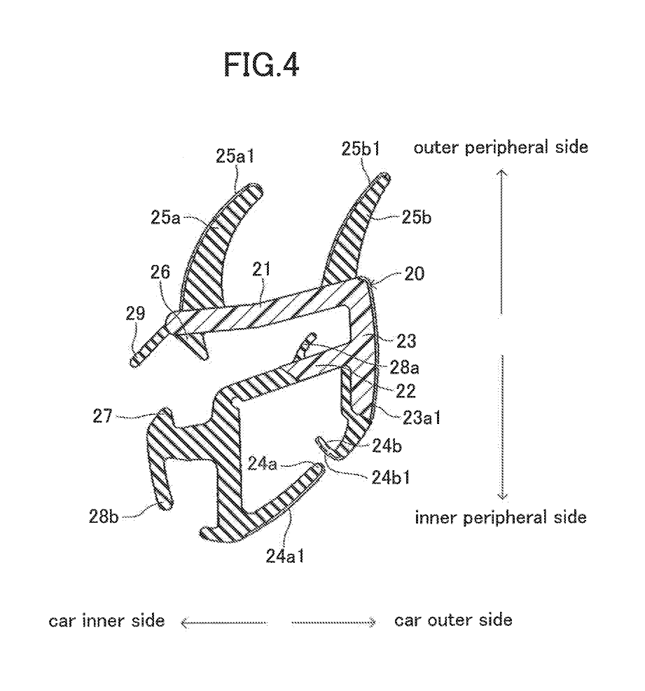

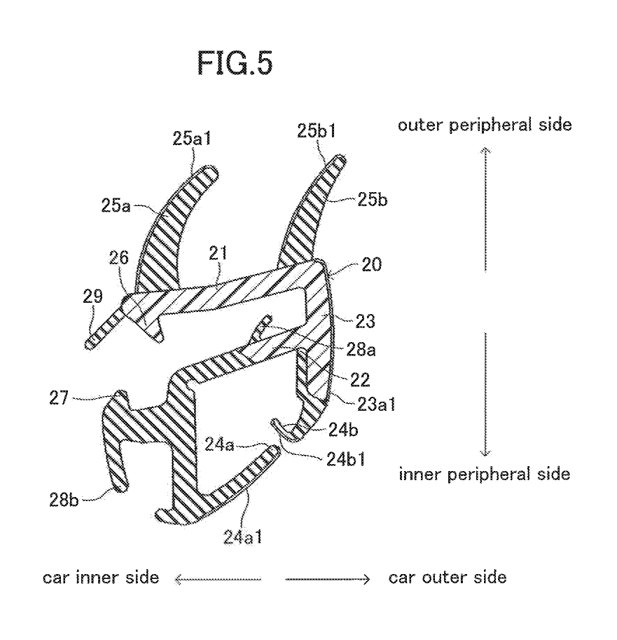

As illustrated in FIGS. 2 to 5, the glass run integral molding 20 includes an outer peripheral-side side wall portion 21 and an inner peripheral-side side wall portion 22, a car outer-side side wall portion 23, a pair of glass run portions 24a and 24b, and a pair of body seal lip portions 25a and 25b in an integrated manner. The outer peripheral-side side wall portion 21 and the inner peripheral-side side wall portion 22 sandwich the flange portion 11b. The car outer-side side wall portion 23 connects a car outer-side end portion of the outer peripheral-side side wall portion 21 and that of the inner peripheral-side side wall portion 22 to each other and extends along a door glass surface. The pair of glass run portions 24a and 24b are formed so as to extend respectively from the inner peripheral-side side wall portion 22 and the car outer-side side wall portion 23 to seal a peripheral edge of the door glass 32. The pair of body seal lip portions 25a and 25b are formed so as to extend from the outer peripheral-side side wall portion 21 toward the outer peripheral side to seal a clearance between the vehicle door VD and a vehicle body 40.

The glass run integral molding 20 also includes an outer peripheral-side engagement portion 26 and an inner peripheral-side engagement portion 27 in an integrated manner. The outer peripheral-side engagement portion 26 is formed so as to extend from a car inner-side end portion of the outer peripheral-side side wall portion 21 to the inner peripheral side and comes into elastic engagement with the first engagement portion C1 formed on an outer peripheral surface of the upper part 11 from the outer peripheral side to the inner peripheral side. The inner peripheral-side engagement portion 27 is formed so as to extend from the inner peripheral-side side wall portion 22 and comes into elastic engagement with the second engagement portion C2 formed on an inner peripheral surface of the upper part 11 from the inner peripheral side to the outer peripheral side. The glass run integral molding 20 also includes a first reinforcing lip 28a and a second reinforcing lip 28b. A distal end portion of the first reinforcing lip 28a comes into elastic engagement with the inner peripheral-side plate 11b3 of the flange portion 11b. The first engagement portion C1 is pressed against the outer peripheral-side engagement portion 26 side by an elastic engagement force of the first reinforcing lip 28a. As a result, an elastic engagement force of the outer peripheral-side engagement portion 26 to the first engagement portion C1 is enhanced. A distal end portion of the second reinforcing lip 28b comes into elastic engagement with the base portion 11a. The second engagement portion C2 is pressed against the inner peripheral-side engagement portion 27 by an elastic engagement force of the second reinforcing lip 28b. As a result, an elastic engagement force of the inner peripheral-side engagement portion 27 to the second engagement portion C2 is enhanced.

A film 23a1 (weather-resistant PP) for preventing deterioration is provided on a surface (design surface) of the car outer-side side wall portion 23, which is oriented to the car outer side. A sliding member 24a1 for reducing friction is provided on a portion of the glass run portion 24a, which is held contact with the door glass 32, whereas a sliding member 24b1 for reducing friction is provided on a portion of the glass run portion 24b, which is held in contact with the door glass 32. Moreover, a sliding member 25a1 for reducing friction is provided on a portion of the body seal lip portion 25a, which is held in contact with the vehicle body 40, whereas a sliding member 25b1 for reducing friction is provided on a portion of the body seal lip portion 25b, which is held in contact with the vehicle body 40. A waterproofing seal lip portion 29 is formed so as to extend from a car inner-side end portion of the outer peripheral-side side wall portion 21. A distal end portion of the seal lip portion 29 comes into elastic engagement with the outer peripheral side of the base portion 11a. In this manner, the interior of the vehicle is protected from water.

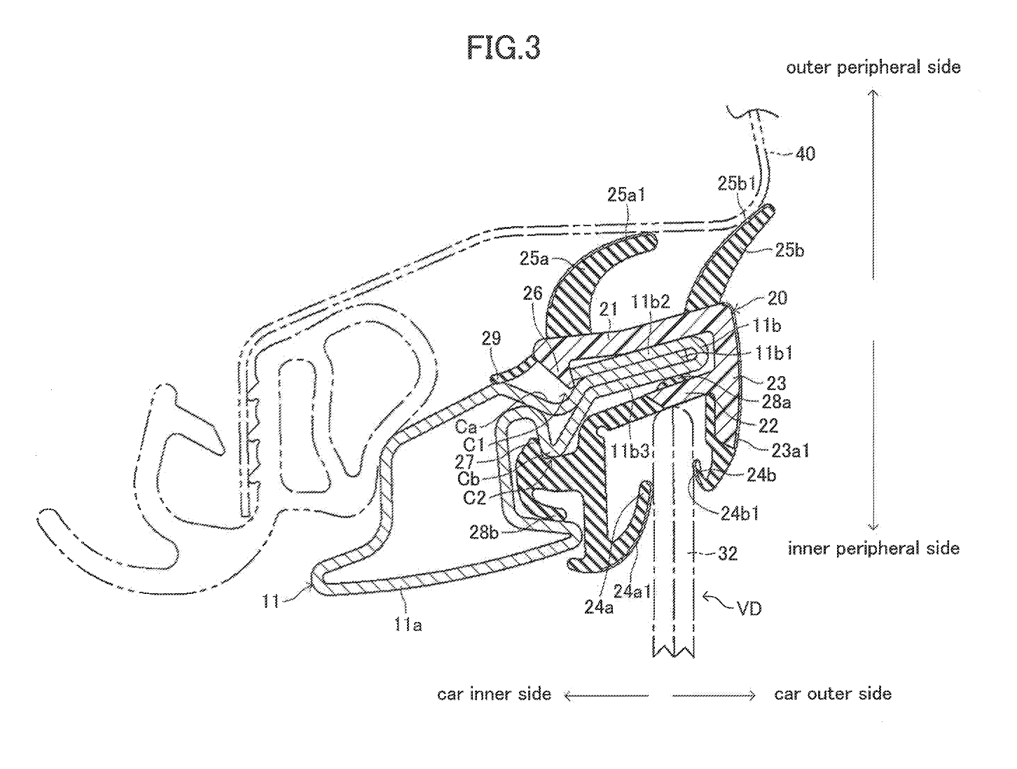

In the glass run integral molding 20 described above, the glass run portions 24a and 24b, the body seal lip portions 25a and 25b, a part of the outer peripheral-side engagement portion 26 (part illustrated in FIG. 2), the inner peripheral-side engagement portion 27, each of the reinforcing lips 28a and 28b, and the waterproofing seal lip portion 29 are made of a soft resin (for example, olefin elastomer (TPO)). On the other hand, the outer peripheral-side side wall portion 21, the inner peripheral-side side wall portion 22, the car outer-side side wall portion 23, and the other part of the outer peripheral-side engagement portion 26 (part illustrated in FIG. 3, and a plurality thereof are provided at predetermined intervals in a longitudinal direction) are made of a hard resin (for example, polypropylene (PP)) harder than the soft resin.

According to the glass run integral molding 20 of this embodiment (first embodiment), which is configured as described above, the outer peripheral-side engagement portion 26 is configured to come into elastic engagement with the first engagement portion C1 formed on the outer peripheral side of the upper part 11 of the door frame 10 from the outer peripheral side and the inner peripheral-side engagement portion 27 is configured to come into elastic engagement with the second engagement portion C2 formed on the inner peripheral side of the upper part 11 from the inner peripheral side. Specifically, a direction in which the outer peripheral-side engagement portion 26 comes into engagement with the first engagement portion C1 and a direction in which the inner peripheral-side engagement portion 27 comes into engagement with the second engagement portion C2 are opposite to each other, and therefore are opposed to each other.

Thus, when the door glass 32 is closed and the glass run integral molding 20 is pushed up from the inner peripheral side to the outer peripheral side, the engagement force of the inner peripheral-side engagement portion 27 to the second engagement portion C2 is strengthened, although the engagement force of the outer peripheral-side engagement portion 26 to the first engagement portion C1 is weakened. By the weakening of one engagement force and the strengthening of the other engagement force, an engagement force of the glass run integral molding 20 to the door frame 10 can be maintained (engagement force can be prevented from being reduced).

Further, according to the glass run integral molding 20 of the first embodiment, the glass run portions 24a and 24b, the body seal lip portions 25a and 25b, a part of the outer peripheral-side engagement portion 26 (part illustrated in FIG. 2), the inner peripheral-side engagement portion 27, each of the reinforcing lips 28a and 28b, and the waterproofing seal lip portion 29 are made of a soft resin, and the outer peripheral-side side wall portion 21, the inner peripheral-side side wall portion 22, the car outer-side side wall portion 23, and the other part of the outer peripheral-side engagement portion 26 (part illustrated in FIG. 3) are made of a hard resin harder than the soft resin.

The glass run portions 24a and 24b, the body seal lip portions 25a and 25b, and the waterproofing seal lip portion 29 are made of the soft resin and hence, come into close contact with counterpart members. Therefore, desired sealability can be obtained. Moreover, the outer peripheral-side side wall portion 21, the inner peripheral-side side wall portion 22, and the car outer-side side wall portion 23 are made of the hard resin. Thus, a shape of the molding constituted by the above-mentioned portions is stabilized. Therefore, desired design (external shape) can be ensured. Further, the firm engagement with the door frame 10 can be obtained at the other part of the outer peripheral-side engagement portion 26 (part illustrated in FIG. 3, which is made of the hard resin). In addition, assembly ease of the glass run integral molding 20 to the door frame 10 can be obtained by the part of the outer peripheral-side engagement portion 26 (part illustrated in FIG. 2, which is made of the soft resin) and the inner peripheral-side engagement portion 27.

Further, according to the glass run integral molding 20 of the first embodiment, the first reinforcing lip 28a for enhancing the elastic engagement force of the outer peripheral-side engagement portion 26 to he first engagement portion C1 and the second reinforcing lip 28b for enhancing the elastic engagement force of the inner peripheral-side engagement portion 27 to the second engagement portion C2 are provided. Therefore, assembly strength of the glass run integral molding 20 to the door frame 10 can be enhanced.

Further, in this first embodiment, the upper part 11 of the door frame 10 is formed by bending the thin steel plate. Moreover, the flange portion 11b has the triple-layered structure in which the intermediate plate 11b1, the outer peripheral-side plate 11b2, and the inner peripheral-side plate 11b3 are laminated. Further, the first engagement portion C1 is configured by the concave portion Ca formed by protruding the car inner-side portion of the intermediate plate 11b1 to the inner peripheral side and the end portion C3 of the outer peripheral-side plate 11b2, which is provided so as to partially overlap the concave portion Ca. The second engagement portion C2 is configured by the projecting portion Cb formed on the inner peripheral-side plate 11b3 so as to correspond to the concave portion Ca to project to the inner peripheral side so that the concave portion Ca is partially present therein. Therefore, the concave portion Ca, which protrudes to the inner peripheral side, can be provided so as to be present in the concave portion formed by the projecting surface and an opposite surface of the projecting portion Cb. Accordingly, a space for configuring the first engagement portion C1 and the second engagement portion C2 can be reduced. As a result, the door frame 10 can be reduced in size as well as in weight.

In the first embodiment described above, an example where the part (see FIG. 2) of the outer peripheral-side engagement portion 26 is made of the soft resin, the other part (see FIG. 3) of the outer peripheral-side engagement portion 26 is made of the hard resin, and the inner peripheral-side engagement portion 27 is entirely made of the soft resin has been described. However, the outer peripheral-side engagement portion 26 may be entirely made of the hard resin, whereas the inner peripheral-side engagement portion 27 may be entirely made of the soft resin.

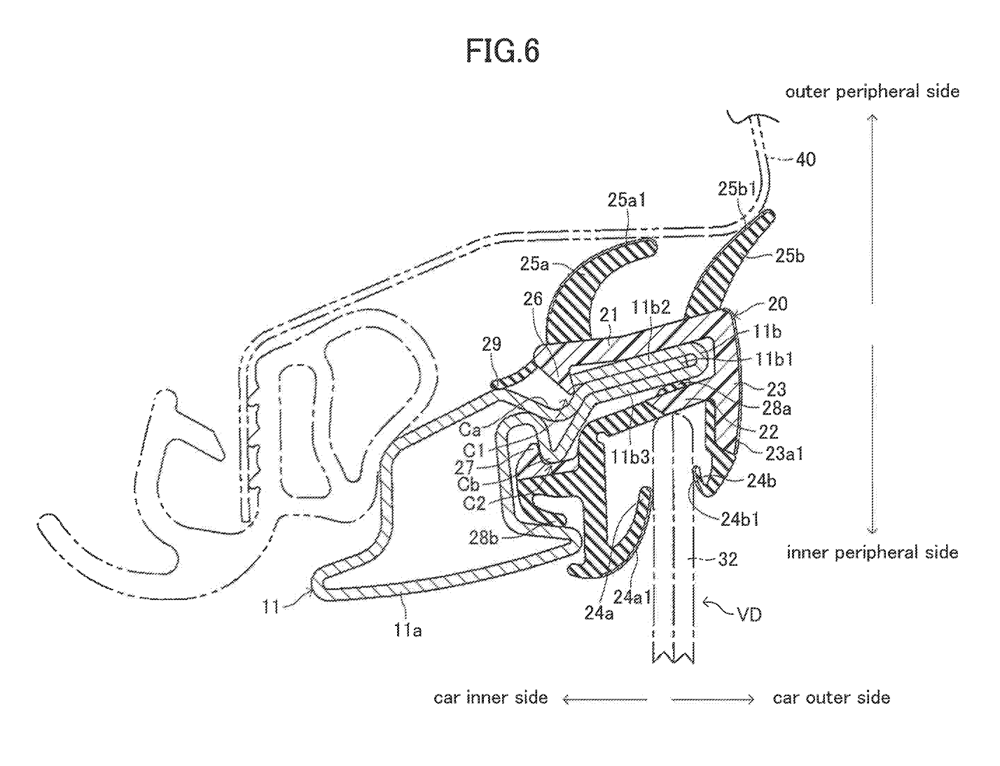

Further, opposite to the first embodiment described above, the part of the inner peripheral-side engagement portion 27 may be made of the soft resin, the other part of the inner peripheral-side engagement portion 27 may be made of the hard resin, and the outer peripheral-side engagement portion 26 may be entirely made of the soft resin. Still further, the inner peripheral-side engagement portion 27 may be entirely made of the hard resin, whereas the outer peripheral-side engagement portion 26 may be entirely made of the soft resin. As in the case of a second embodiment illustrated in FIG. 6, both the outer peripheral-side engagement portion 26 and the inner peripheral-side engagement portion 27 may be entirely made of the hard resin.

In each of the embodiments described above, an example where the first reinforcing lip 28a for enhancing the elastic engagement force of the outer peripheral-side engagement portion 26 to the first engagement portion C1 and the second reinforcing lip 28b for enhancing the elastic engagement force of the inner peripheral-side engagement portion 27 to the second engagement portion C2 are both provided has been described. However, any one of the reinforcing lips may be omitted. Further alternatively, both of the reinforcing lips may be omitted.

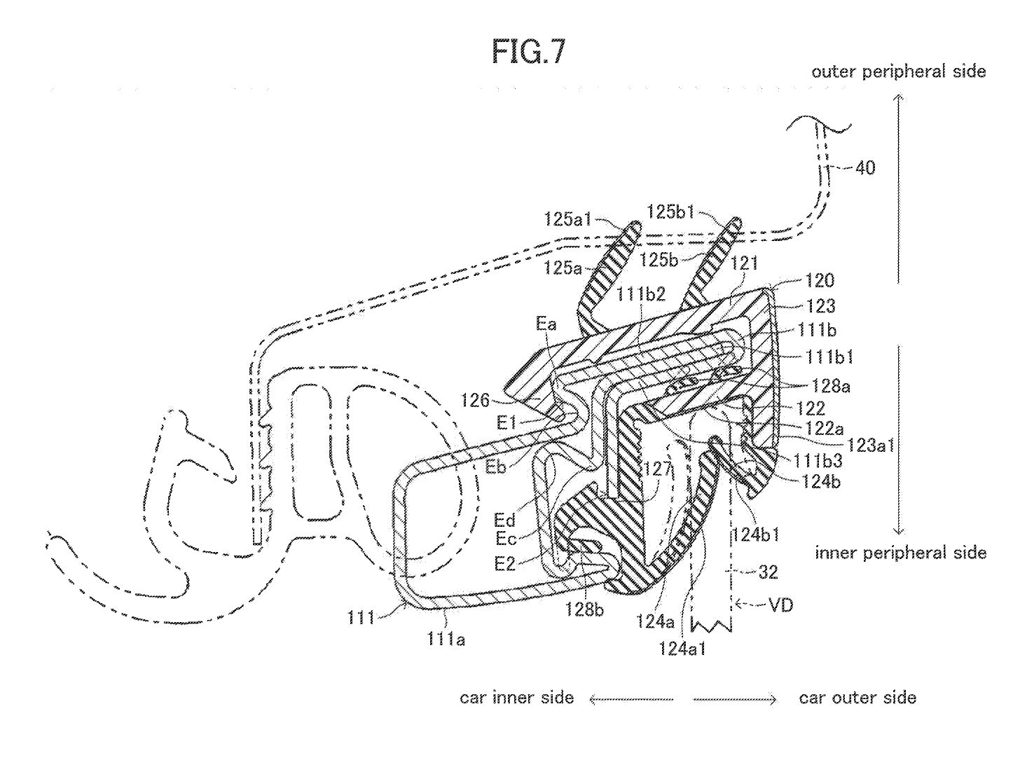

In each of the embodiments described above, the flange portion 11b of the upper part 11 of the door frame 10 has the triple-layered structure in which the intermediate layer 11b1, the outer peripheral-side plate 11b2, and the inner peripheral-side plate 11b3 are laminated. The first engagement portion C1, with which the outer peripheral-side engagement portion 26 comes into elastic engagement from the outer peripheral side, is configured by the concave portion Ca and the end portion C3 of the outer peripheral-side plate 11b2, whereas the second engagement portion C2, with which the inner peripheral-side engagement portion 27 comes into elastic engagement from the inner peripheral side, is configured by the projecting portion Cb formed so as to correspond to the concave portion Ca. The shape and configuration of the flange portion 11b and the shapes and configurations of the first engagement portion C1 and the second engagement portion C2 can be appropriately changed as described in, for example, third to sixth embodiments illustrated in FIGS. 7 to 10, and therefore are not limited to the shapes and configurations of each of the embodiments described above.

In the third embodiment illustrated in FIG. 7, an upper part 111 of the door frame is formed by bending a thin steel plate, and includes a hollow base portion 111a and a flange portion 111b. The flange portion 111b has a triple-layered structure in which an intermediate plate 111b1, an outer peripheral-side plate 111b2, and an inner peripheral-side plate 111b3 are laminated. The layers of the steel plate are spot-welded at an overlapping portion. A car inner-side portion of the outer peripheral-side plate 111b2 of the flange portion 111b is protruded to the car inner side and the car outer side to form a convex portion Ea and a concave portion Eb. A first engagement portion E1 is configured by any one or both of the convex portion Ea and the concave portion Eb. Moreover, a car inner-side portion of the intermediate plate 111b1 of the flange portion 111b is bent to the inner peripheral side. A further portion is protruded to the inner peripheral side and the outer peripheral side to form a second convex portion Ec and a second concave portion Ed. An end portion of the inner peripheral-side plate 111b3 is bent to the inner peripheral side so as to partially overlap the second convex portion Ec. A second engagement portion E2 is configured by at least one of the second convex portion Ec, the second concave portion Ed, and the end portion of the inner peripheral-side plate 111b3. In the third embodiment illustrated in FIG. 7, the second engagement portion E2 is configured by the end portion of the inner peripheral-side plate 111b3.

In the third embodiment illustrated in FIG. 7, a glass run integral molding 120 to be assembled to the upper part 111 is configured in the same manner as that of the glass run integral molding 20 illustrated in FIG. 3. Specifically, the glass run integral molding 120 includes an outer peripheral-side side wall portion 121 and an inner peripheral-side side wall portion 122, a car outer-side side wall portion 123, a pair of glass run portions 124a and 124b, and a pair of body seal lip portions 125a and 125b in an integrated manner. The outer peripheral-side side wall portion 121 and the inner peripheral-side side wall portion 122 sandwich the flange portion 111b. The car outer-side side wall portion 123 connects a car outer-side end portion of the outer peripheral-side side wall portion 121 and that of the inner peripheral-side side wall portion 122 to each other and extends along a door glass surface. The pair of glass run portions 124a and 124b are formed so as to extend respectively from the inner peripheral-side side wall portion 122 and the car outer-side side wall portion 123 to seal a peripheral edge of the door glass 32. The pair of body seal lip portions 125a and 125b are formed so as to extend from the outer peripheral-side side wall portion 121 to the outer peripheral side to seal a clearance between the vehicle door VD and the vehicle body 40.

The glass run integral molding 120 further includes an outer peripheral-side engagement portion 126 and an inner peripheral-side engagement portion 127 in an integrated manner. The outer peripheral-side engagement portion 126 is formed so as to extend from a car inner-side end portion of the outer peripheral-side side wall portion 121 to the inner peripheral side and comes into elastic engagement with the first engagement portion E1 formed on an outer peripheral side of the upper part 111 from the outer peripheral side to the inner peripheral side. The inner peripheral-side engagement portion 127 is formed so as to extend from the inner peripheral-side side wall portion 122 and comes into elastic engagement with the second engagement portion E2 (end portion of the inner peripheral-side plate 111b3) formed on the inner peripheral side of the upper part 111 from the inner peripheral side to the outer peripheral side. The glass run integral molding 120 also includes a first reinforcing lip 128a and a second reinforcing lip 128b. A distal end portion of the first reinforcing lip 128a comes into elastic engagement with the flange portion 111b to enhance an elastic engagement force of the outer peripheral-side engagement portion 126 to the first engagement portion E1. A distal end portion of the second reinforcing lip 128b comes into elastic engagement with the base portion 111a to enhance an elastic engagement force of the inner peripheral-side engagement portion 127 to the second engagement portion E2.

A metallic film 123a1 for a high-quality look is provided on a surface (design surface) of the car outer-side side wall portion 123, which is oriented to the car outer side, A sliding member 124a1 for reducing friction is provided on a portion of the glass run portion 124a, which comes into engagement with the door glass 32, whereas a sliding member 124b1 for reducing friction is provided on a portion of the glass run portion 124b, which comes into engagement with the door glass 32. Moreover, a sliding member 125a1 for reducing friction is provided on a portion of the body seal lip portion 125a, which comes into engagement with the vehicle body 40, whereas a sliding member 125b1 for reducing friction is provided on a portion of the body seal lip portion 125b, which comes into engagement with the vehicle body 40. In this third embodiment, the end portion of the inner peripheral-side plate 111b3 of the flange portion 111b is protected from water by the first reinforcing lip 128a. Therefore, a configuration corresponding to the waterproofing seal lip portion 29 as illustrated in FIG. 2 is not required. Therefore, the cost of the glass run integral molding 120 can be reduced.

In the glass run integral molding 120 described above, the glass run portions 124a and 124b, the body seal lip portions 125a and 125b, the inner peripheral-side engagement portion 127, and each of the reinforcing lips 128a and 128b are made of a soft resin (for example, olefin elastomer (TPO)). On the other hand, the outer peripheral-side side wall portion 121, the inner peripheral-side side wall portion 122, the car outer-side side wall portion 123, and the outer peripheral-side engagement portion 126 are made of a hard resin (for example, polypropylene (PP)) harder than the soft resin.

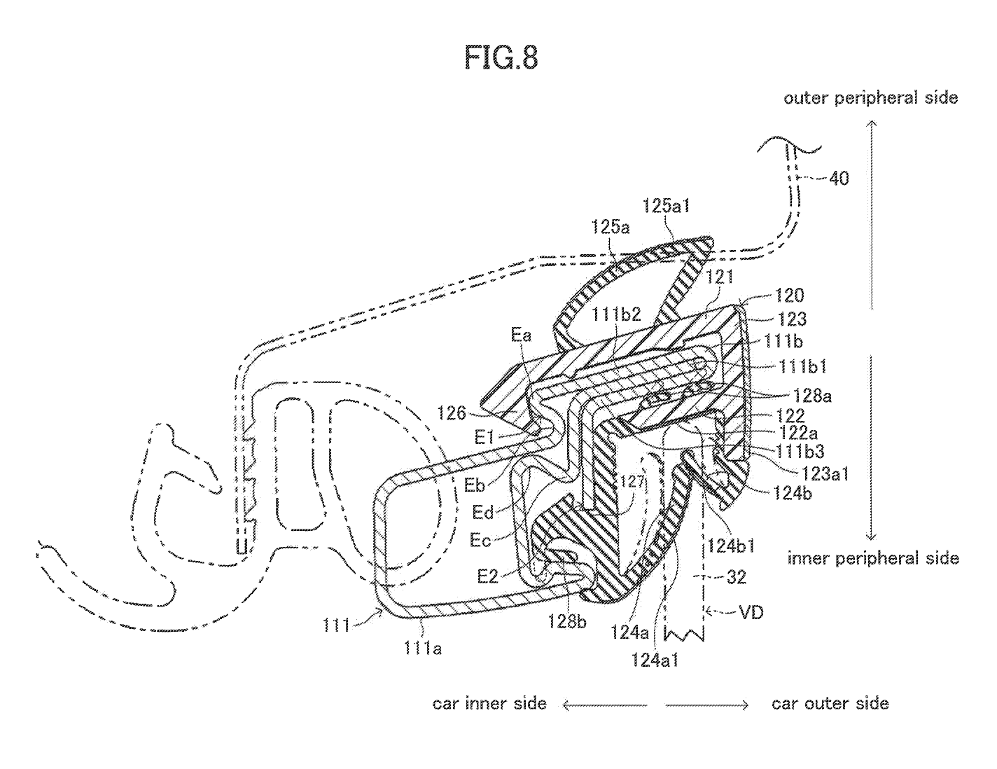

In the fourth embodiment illustrated in FIG. 8, the body seal lip portion 125a for sealing the clearance between the vehicle door VD and the vehicle body 40 is formed in a hollow fashion. Therefore, as compared with the third embodiment illustrated in FIG. 7, the body seal lip portion 125a can be prevented from being flat. The remaining configuration is the same as that of the third embodiment illustrated in FIG. 7. Therefore, the same parts are denoted by the same reference numerals, and the description thereof is herein omitted.

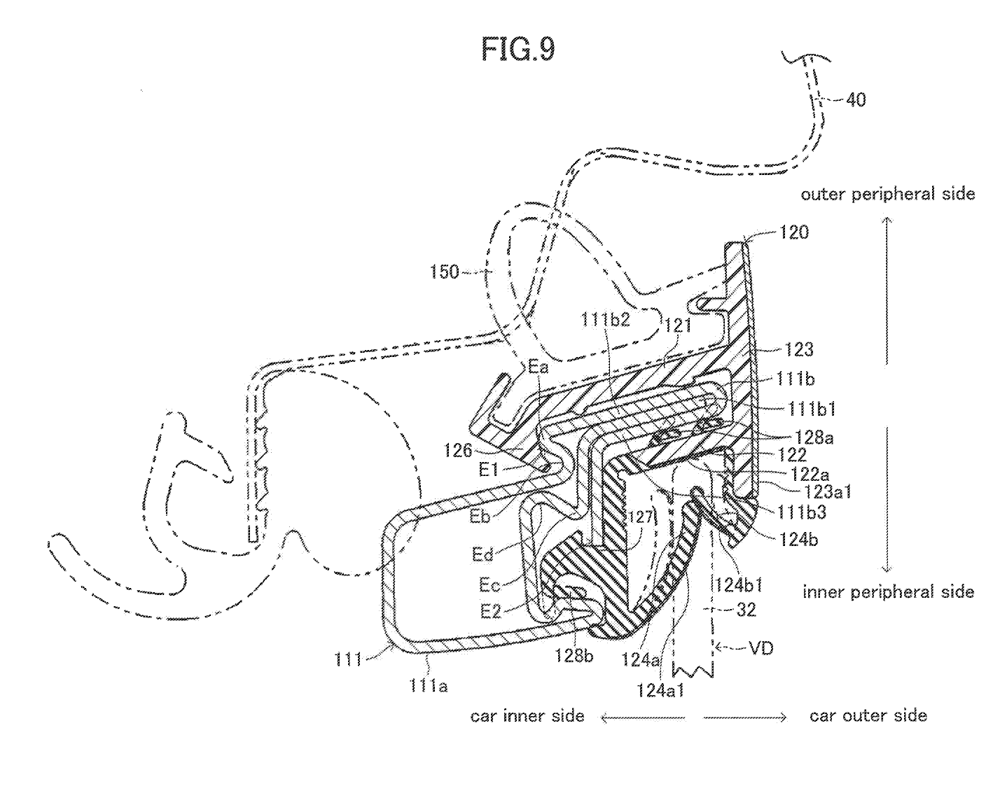

In the fifth embodiment illustrated in FIG. 9, a body seal lip portion (hollow weather strip) 150 for sealing the clearance between the vehicle door VD and the vehicle body 40 is formed independently of the glass run integral molding 120 so as to be removable therefrom. Therefore, in this embodiment, the body seal lip portion 150 can be replaced as needed. The remaining configuration is the same as that of the third embodiment illustrated in FIG. 7. Therefore, the same parts are denoted by the same reference numerals, and the description thereof is herein omitted.

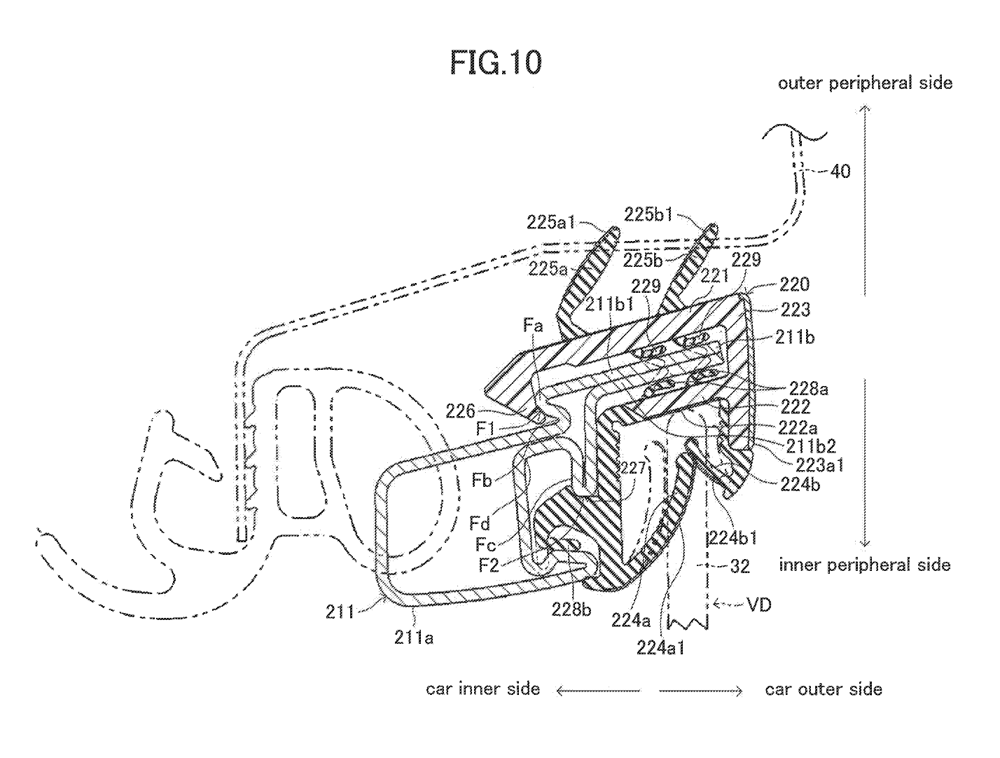

In the sixth embodiment illustrated in FIG. 10, an upper part 211 of the door frame is formed by bending a thin steel plate, and includes a hollow base portion 211a and a flange portion 211b. The flange portion 211b has a double-layered structure in which an outer peripheral-side plate 211b1 and an inner peripheral-side plate 211b2 are laminated and are spot-welded at an overlapping portion. Since the flange portion 211b has the double-layered structure of the thin steel plate, weight and cost can be reduced as compared with the case of the triple-layered structure. Moreover, an end portion of the flange portion 211b is easy to spot-weld to a door inner panel (not shown) of the vehicle door VD. The portion welded to the door inner panel forms the triple-layered structure of the thin steel plate. A car inner-side portion of the outer peripheral-side plate 211b1 of the flange portion 211b is protruded to the car inner side and the car outer side to form a convex portion Fa and a concave portion Fb. A first engagement portion F1 is configured by any one or both of the convex portion Fa and the concave portion Fb. Moreover, by bending a car inner-side portion of the inner peripheral-side plate 211b2 of the flange portion 211b to the inner peripheral side and then folding the car inner-side portion, a second convex portion Fc is formed. A second engagement portion F2 is configured by the second convex portion Fc.

In the sixth embodiment illustrated in FIG. 10, a glass run integral molding 220 to be assembled to the upper part 211 is configured in the same manner as that of the glass run integral molding 120 of the third embodiment, which is illustrated in FIG. 7. In the glass run integral molding 220 according to the this sixth embodiment, a pair of seal lip portions 229 are integrally provided on the inner peripheral side of an outer peripheral-side side wall portion 221 so as to protect from water the end portion of the outer peripheral-side plate 211b1 of the flange portion 211b. The remaining configuration of the glass run integral molding 220 is the same as that of the glass run integral molding 120 of the third embodiment illustrated in FIG. 7. Therefore, the same parts are denoted by the same reference numerals, and the description thereof is herein omitted.

In the sixth embodiment illustrated in FIG. 10, the flange portion 211b of the upper part 211 of the door frame has the double-layered structure of the thin steel plate. Therefore, as compared with the first to fifth embodiments described above (embodiments where the flange portion has the triple-layered structure of the thin steel plate), the door frame can be reduced in weight. Moreover, in the sixth embodiment, an operation of firmly fixing a lower end portion of the door flame (lower end portion of the upper part 11 of the door frame 10 illustrated in FIG. 1) to the door panel (for example, the door inner panel) at the flange portion 211b (for example, an operation of spot-welding three layers of the steel plate) is easier than a similar operation performed in the first to fifth embodiments described above (operation of spot-welding four layers of the steel plate).

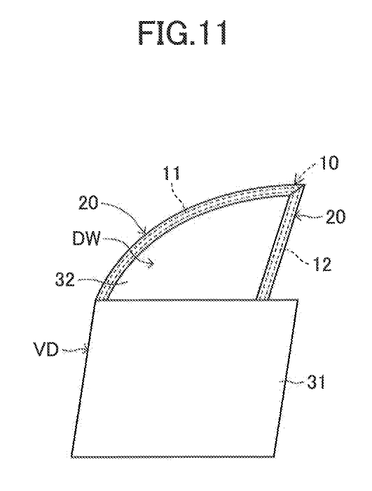

In each of the embodiments described above (first to sixth embodiments), the present invention is carried out for the glass run integral molding (20, 120, 220) to be assembled to the upper part (11, 111, 211) of the door frame. However, the glass run integral molding of the present invention can also be used for a column part (which has approximately the same sectional shape as that of the upper part) of the door frame. For example, as exemplified in FIG. 11, the glass run integral molding 20 can be used for both the upper part 11 and the column part 12 (which have approximately the same sectional shape) of the door frame 10. In this case, the glass run integral molding 20 used for the upper part 11 and the glass run integral molding 20 used for the column part 12 can be integrally formed. The configuration of the embodiment exemplified in FIG. 11 is the same as that of the embodiment illustrated in FIG. 1 except that the glass run integral molding 20 is also used for the column part 12 (having the same sectional shape as that of the upper part 11) and the garnish 33 is not provided to the column part 12. In the embodiment illustrated in FIG. 1, the garnish 33 is provided to the column part 12, and therefore the molding is not required. Accordingly, a general glass run (not shown) is used for the column part 12 instead of the glass run integral molding 20.

Further, in each of the embodiments described above, an example where the present invention is applied to the glass run integral molding to be assembled to the upper part of the door frame of the front door has been described. The present invention can also be applied to a glass run integral molding to be assembled to a door frame of a rear door in the same manner as that of each of the embodiments or with an appropriate change.

1. A glass run integral molding adapted to be assembled to a door frame surrounding a window opening of a vehicle door, comprising:
an outer peripheral-side side wall portion and an inner peripheral-side side wall portion for sandwiching a flange portion provided to the door frame;
a car outer-side side wall portion for connecting a car outer side end portion of the outer peripheral-side side wall portion and a car outer side end portion of the inner peripheral-side side wall portion to each other and extending along a door glass surface;
a pair of glass run portions formed so as to extend from the inner peripheral-side side wall portion and the car outer-side side wall portion to seal a peripheral edge of a door glass;
a body seal lip portion formed so as to extend from the outer peripheral-side side wall portion toward an outer peripheral side to seal a clearance between the vehicle door and a vehicle body;
an outer peripheral-side engagement portion formed so as to extend from the outer peripheral-side side wall portion, for coming into elastic engagement with a first engagement portion formed on an outer peripheral side of the door frame from the outer peripheral side; and
an inner peripheral-side engagement portion formed so as to extend from the inner peripheral-side side wall portion, for coming into elastic engagement with a second engagement portion formed on an inner peripheral side of the door frame from the inner peripheral side.

2. A glass run integral molding according to claim 1, wherein:
the pair of glass run portions and the body seal lip portion are made of a soft resin;
the outer peripheral-side side wall portion, the inner peripheral-side side wall portion, and the car outer-side side wall portion are made of a hard resin harder than the soft resin;
at least a part of one of the outer peripheral-side engagement portion and the inner peripheral-side engagement portion is made of the hard resin; and
another one of the outer peripheral-side engagement portion and the inner peripheral-side engagement portion is made of the soft resin.

3. A glass run integral molding according to claim 1, further comprising at least one of:
a first reinforcing lip having a distal end portion for coming into elastic engagement with the door frame to enhance an elastic engagement force of the outer peripheral-side engagement portion to the first engagement portion; and
a second reinforcing lip having a distal end portion for coming into elastic engagement with the door frame to enhance an elastic engagement force of the inner peripheral-side engagement portion to the second engagement portion.

4. A door frame structure, comprising:
a door frame having a flange portion and surrounding a window opening of a vehicle door; and
a glass run integral molding to be assembled to the door frame, comprising:
an outer peripheral-side side wall portion and an inner peripheral-side side wall portion for sandwiching the flange portion of the door frame;
a car outer-side side wall portion for connecting a car outer-side end portion of the outer peripheral-side side wall portion and a car outer-side end portion of the inner peripheral-side side wall portion to each other and extending along a door glass surface;
a pair of glass run portions formed so as to extend from the inner peripheral-side side wall portion and the car outer-side side wall portion to seal a peripheral edge of a door glass;
a body seal Hp portion formed so as to extend from the outer peripheral-side side wall portion toward an outer peripheral side to seal a clearance between the vehicle door and a vehicle body;
an outer peripheral-side engagement portion formed so as to extend from the outer peripheral-side side wall portion, for coming into elastic engagement with a first engagement portion formed on an outer peripheral side of the door frame from the outer peripheral side; and
an inner peripheral-side engagement portion formed so as to extend from the inner peripheral-side side wall portion, for coming into elastic engagement with a second engagement portion formed on an inner peripheral side of the door frame from the inner peripheral side.

5. A door frame structure according to claim 4, wherein:
the door frame is formed by bending a thin steel plate so that the flange portion has a triple-layered structure in which an intermediate plate, an outer peripheral-side plate, and an inner peripheral-side plate are laminated;
the first engagement portion is configured by a concave portion formed by protruding a car inner-side portion of the intermediate plate to the inner peripheral side and an end portion of the outer peripheral-side plate, which is provided so as to partially overlap the concave portion; and
the second engagement portion is configured by a projecting portion formed on the inner peripheral-side plate so as to correspond to the concave portion to project to the inner peripheral side.

6. A door frame structure according to claim 4, wherein:
the door frame is formed by bending a thin steel plate so that the flange portion has a triple-layered structure in which an intermediate plate, an outer peripheral-side plate, and an inner peripheral-side plate are laminated;
the first engagement portion is configured by at least one of a convex portion and a concave portion respectively formed by protruding a car inner-side portion of the outer peripheral-side plate to a car inner side and a car outer side; and
the second engagement portion is configured by at least one of a second convex portion and a second concave portion formed by bending a car inner-side portion of the intermediate plate to the inner peripheral side and protruding to the car inner side and the outer peripheral side, and an end portion of the inner peripheral-side plate, which is bent to the inner peripheral side so as to partially overlap the second convex portion.

7. A door frame structure according to claim 4, wherein:
the door frame is formed by bending a thin steel plate so that the flange portion has a double-layered structure in which an outer peripheral-side plate and an inner peripheral-side plate are laminated;
the first engagement portion is configured by at least one of a convex portion and a concave portion respectively formed by protruding a car inner-side portion of the outer peripheral-side plate to a car inner side and a car outer side; and
the second engagement portion is configured by a second convex portion formed by bending a car inner-side portion of the inner peripheral-side plate to the inner peripheral side and then folding the car inner-side portion.

8. A door frame structure, comprising:
a door frame having a flange portion and surrounding a window opening of a vehicle door; and
a glass run integral molding to be assembled to the door frame, comprising:
an outer peripheral-side side wall portion and an inner peripheral-side side wall portion for sandwiching the flange portion of the door frame;
a car outer-side side wall portion for connecting a car outer-side end portion of the outer peripheral-side side wall portion and a car outer-side end portion of the inner peripheral-side side wall portion to each other and extending along a door glass surface;
a glass run portion formed so as to extend from the inner peripheral-side side wall portion and the car outer-side side wall portion to seal a peripheral edge of a door glass;
a body seal lip portion formed so as to extend from the outer peripheral-side side wall portion toward an outer peripheral side to seal a clearance between the vehicle door and a vehicle body;
an outer peripheral-side engagement portion formed so as to extend from the outer peripheral-side side wall portion, for coming into elastic engagement with a first engagement portion formed on an outer peripheral side of the door frame from the outer peripheral side; and
an inner peripheral-side engagement portion formed so as to extend from the inner peripheral-side side wall portion, for coming into elastic engagement with a second engagement portion formed on an inner peripheral side of the door frame from the inner peripheral side;
wherein:
the door frame is formed by bending a thin steel plate so that the flange portion has a triple-layered structure in which an intermediate plate, an outer peripheral-side plate, and an inner peripheral-side plate are laminated;
the first engagement portion is configured by a concave portion formed by protruding a car inner-side portion of the intermediate plate to the inner peripheral side and an end portion of the outer peripheral-side plate, which is provided so as to partially overlap the concave portion; and
the second engagement portion is configured by a projecting portion formed on the inner peripheral-side plate so as to correspond to the concave portion to project to the inner peripheral side.
